(19) United States
(12) Patent Application Publication
(10) Pub. No.: US 2009/0040174 A1
(43) Pub. Date: Feb. 12, 2009

(54) DISPLAY DEVICES AND ELECTRONIC DEVICES

(75) Inventor: Keitaro YAMASHITA, Kobe (JP)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/187,626

(22) Filed: Aug. 7, 2008

(30) Foreign Application Priority Data
Aug. 10, 2007 (JP) JP2007-210154

(51) Int. Cl. G09G 3/36

(52) U.S. Cl. 345/104

(57) ABSTRACT

Display devices with image sensors are provided. Display pixel portions are disposed at intersections of gate lines and source lines and arranged as a matrix. Each display pixel portion includes a liquid crystal element, a photo detector detecting an incident light, a hold device sustaining an analog first data corresponding to a light flux of the incident light detected by the photo detector, and a data determination device generating a second data according to the first data sustained by the hold device. A gate driver selectively activates the gate lines. A source driver provides display data to the source lines. An output device retrieves the analyzed output data. The analyzed output data is the second data output by the data determination device through the source lines. A sensitivity control device changes a determination base of the analyzed output data corresponding to the intensity of the incident light.

### CROSS REFERENCE TO RELATED APPLICATIONS

This Application claims priority of Japan Patent Application No. 2007-210154, filed on Aug. 10, 2007, the entirety of which is incorporated by reference herein.

### BACKGROUND OF THE INVENTION

1. Field of the Invention

The invention relates to display devices, and more particularly to display devices with image sensors for fingerprint identification.

2. Description of the Related Art

For safety requirements, display devices with image capture functions such as fingerprint identification have been popularly applied on mobile phones, personal digital assistants (PDAs), and computers.

The aforementioned display devices are hybrid type that comprise a liquid crystal (LC) display with LC capacitors in array arrangement and switched by transistors, and image sensors formed on surface layers of the display panel. The image sensors include photo detectors in each or some pixels of the liquid crystal display device to detect reflective fingerprint images, capacitors sustaining voltages corresponding to the light flux detected by the photo detectors, and analog to digital (A/D) converters converting voltages stored in the capacitors to a one bit digital data, the teaching of which is incorporated by reference in patent document 1.

FIG. 1 is a circuit diagram of conventional display devices capable of performing fingerprint identification as disclosed in patent document 1, in which one pixel is illustrated.

A transistor 10 is disposed at the intersection of a source line Sk and a gate line G. The gate of the transistor 10 is coupled to the gate line G and the source of the transistor 10 is coupled to the source line Sk. A liquid crystal element labeled by the capacitor Clc is coupled between the drain of the transistor 10 and a ground, which has the same structure as well-known liquid crystal displays.

Meanwhile, a fingerprint data acquirement device 20 is further disposed. A cathode of a photodiode 11 is connected to a power source Vdd. An anode of a photodiode 11 is connected to a sample switch 12. Another terminal of the sample switch 12 is connected to one terminal of a hold condenser 13. The other terminal of the hold condenser 13 is grounded, wherein the hold condenser 13 is used for storing charges generated corresponding to the light flux of the photodiode 11.

A refresher device 18 and a readout switch 19 are connected between the connection point N1 of the sample switch 12 and the hold condenser 13, and the source line Sk.

The refresher device 18 includes a first refresher switch 14, a refresher buffer 15, and a second and a third refresher switch 16 and 17, wherein the aforementioned devices are circularly connected. The refresher buffer 15 is formed by a first inverter 151 and a second inverter 152 connected in serial between the power sources Vdd and Vss. The first inverter 151 and the second inverter 152 are respectively formed by complementary transistors with common gates.

For the aforementioned conventional display devices, if the readout switch 19 is turned off, the conventional display devices resemble a typical liquid crystal display device. The charges generated by the photodiode 11 are gathered and stored in the hold condenser 13 when the sample switch 12 is turned on in a predetermined time period. Here, the stored charges are indicated as an analogue value proportional to the charge quantity. The analogue value further transmits to the refresher buffer 15 via the switch 14. The refresher buffer 15 is a static memory, which compares a threshold value of the transistor with the analogue value of the hold condenser 13, and generates binary digits 0 or 1 respectively corresponding to “white” or “black” data. Since the transistor 14 is turned off, the binary digits can be restored in the hold condenser via the transistors 16 and 17.

To read the binary digits stored in the hold condenser 13 from the source line Sk, the transistors 12, 14 and 16 are turned off and the transistors 17 and 19 are turned on. Moreover, the source line Sk is employed to provide displaying data for the liquid crystal display device and to output data from the photodiodes. The above mentioned procedures can be performed using time sharing.

Accordingly, the conventional liquid crystal display device with image sensors is capable of displaying images and transforming a detected result from a reflective light due to fingerprints or the likes in a pixel to output a one bit digital form, i.e., binary digits 0 and 1 corresponding to “white” and “black” data.

The cited reference is Japanese patent laid open No. 2006-121452 (corresponding to Patent Cooperation Treaty (PCT) publication No. WO2006/043216).

### BRIEF SUMMARY OF THE INVENTION

However, the aforementioned display devices integrated with image sensors may not effectively function as main applications for applications such as fingerprint identification. That is, under circumstances such as when dirt or dust exists and there is a high difference between the shading of color, one bit of data cannot acquire sufficient information for comparison with the stored base data, thus resulting in lowered identification accuracy.

Meanwhile, according to characteristics of the photo detectors, a “black smash” phenomenon or a “white smash” phenomenon may occur due to the issues of black or white data saturation, causing identification failed.

The aforementioned constraints can be solved by multi-digital sampling of the fingerprint data and multi-digital sampling of the mean value of the sampled data. However, with the allowable area for forming fingerprint sensors in the display device limited, it is impossible to dispose a structure for multi-digitalized processing on each pixel.

In order to solve the aforementioned constraints, embodiments of the invention provide display devices with image sensors to analyze images and which are capable of processing mean values.

An embodiment of a display device comprises a plurality of display pixel portions disposed at intersections by columns of gate lines and rows of source lines and arranged as a matrix, wherein each display pixel portion comprises a liquid crystal element, a photo detector detecting an incident light, a hold device sustaining an analog first data corresponding to a light flux of the incident light detected by the photo detector, and a data determination device generating a second data according to the first data sustained by the hold device. Meanwhile, a gate driver selectively activates the gate lines, a source driver provides display data to the source lines, and an output device retrieves an analyzed output data, wherein the analyzed output data is the second data output by the data determination device through the source lines. Additionally, a sensitivity control device changes a determination base of the analyzed output data corresponding to the intensity of the incident light.

According to embodiments of the invention, a processed mean value and identification data is compared with higher accuracy using the same one-bit structure as related arts.

### BRIEF DESCRIPTION OF THE DRAWINGS

The invention can be more fully understood by reading the subsequent detailed description and examples with references made to the accompanying drawings, wherein:

FIG. 1 is a circuit diagram of conventional display devices capable of performing fingerprint identification;

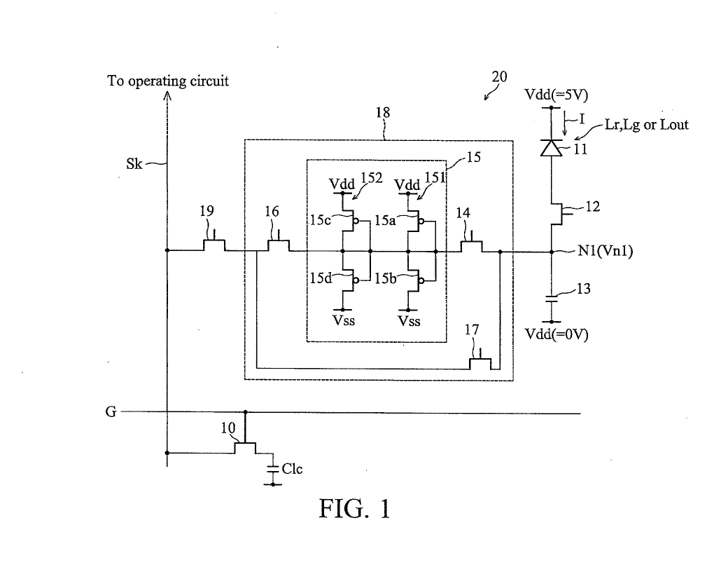

FIG. 2 is a schematic flowchart of an embodiment of the liquid crystal display device 100 of the invention;

FIG. 3 shows a schematic diagram according to the first embodiment of the invention, wherein the sample interval is adjusted;

FIGS. 4A and 4B are timing diagrams showing operation of the circuit in FIG. 3;

FIG. 5 shows a schematic diagram according to the second embodiment of the invention;

FIGS. 6A and 6B are timing diagrams showing operation of the circuit in FIG. 5;

FIG. 7 shows a schematic diagram according to the third embodiment of the invention;

FIGS. 8A and 8B are timing diagrams showing operation of the circuit in FIG. 7;

FIG. 9 shows a schematic diagram according to the fourth embodiment of the invention;

FIGS. 10A and 10B are timing diagrams showing operation of the circuit in FIG. 9;

FIG. 11 shows a schematic diagram according to the fifth embodiment and the sixth embodiment of the invention;

FIGS. 12A and 12B show operation of the sixth embodiment of the invention;

FIG. 13 is a timing diagram to control the sensitivity of a photo detector according to the embodiments of the invention;

FIG. 14 shows statuses of analyzed data corresponding to different levels; and

FIG. 15 is a schematic diagram of an embodiment of a display device of a mobile phone set of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

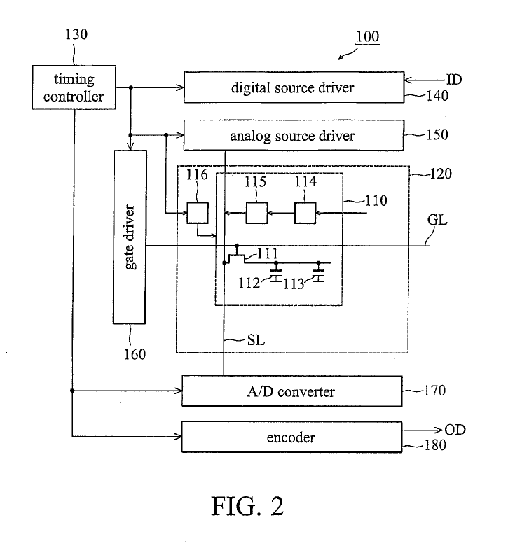

FIG. 2 is a schematic flowchart of an embodiment of the liquid crystal display device 100 of the invention.

An array of liquid crystal 120 corresponds to one pixel of display pixels 110 which is arranged as an array matrix. In each display pixel 110, the gate of a transistor 111 is coupled to the gate line GL and the source of the transistor 111 is coupled to the source line SL. A liquid crystal element 112 labeled by a capacitor is coupled between the drain of transistor 111 and a ground. An auxiliary capacitor 113 connected in parallel with the liquid crystal element 112 is implemented to control the amount of charge storage.

The source line SL is driven by a digital source driver 140 and an analog source driver 150. The digital source driver 140 outputs signals equivalent to the voltage applied to the source lines SL in response to the input data ID according to the control of the timing controller 130. The analog source driver 150 generates output voltages according to the output signal of the digital source driver 140.

Additionally, the gate lines GL respectively activate each scan line in sequence according to the gate driver 160 controlled by the timing controller 130.

The state of the charge storage in the liquid crystal element 112 is controlled by the transistor 111 at an intersection between the source line SL driven by the source driver 150 and the gate line GL driven by the gate driver 160 to vary the liquid crystal transmittance so as to display images.

In this embodiment, the structure of the image sensor for fingerprint identification is described as follows.

Each pixel 110 comprises a photo detector 114 for detecting an incident light L1 and a hold device 115 to store the output of the photo detector 114.

Further, a sensitivity control device 116 is disposed to operate on each pixel. While the sensitivity control device 116 is controlled by the timing controller 130, operation methods thereof have various aspects as disclosed in the following.

The photo detector 114 detects reflective lights from fingerprints. Since the generated current varies with the light intensity, charge amount stored in the capacitor in a predetermined period is varied accordingly. The voltage is determined by dividing the charge amount difference by capacitance C. The voltage is stored in the hold device 115. During the period that the source line does not provide a signal corresponding to the display image data, the voltage can be retrieved through the source line. Subsequently, the voltage is converted into digital data by an analog to digital (A/D) converter 170. Next, the digital data is encoded by an encoder 180 to acquire output data OD corresponding to the bright and dark data of the fingerprint images. Simultaneously, the sensitivity control device 116 adjusts the sensitivity analysis and determines the most suitable level for retrieving fingerprint data.

Next, operation of the device for controlling sensitivity of the image sensor is disclosed as follows.

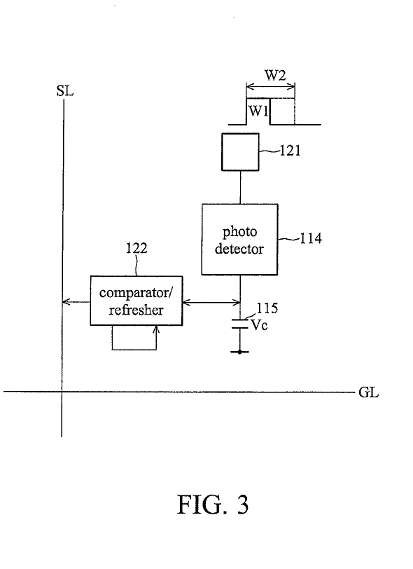

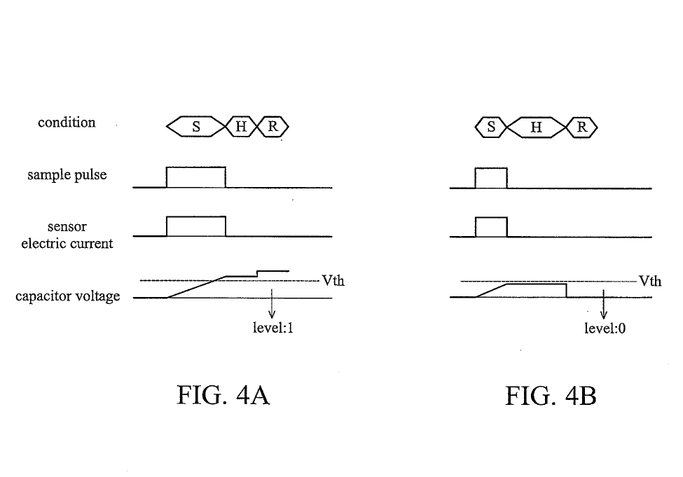

FIG. 3 shows a schematic diagram according to the first embodiment of the invention, wherein the sample interval is adjusted. FIGS. 4A and 4B are timing diagrams showing operation of the circuit in FIG. 3.

The photo detector 114 detects light within a sampling period. Therefore, in FIG. 3, the sampling pulse width adjusting circuit 121 adjusts pulse width of the sampling pulse between W1 and W2. In this example, the sampling pulse width adjusting circuit 121 is a normal circuit for pulse width control, which is well-known in the related arts.

FIGS. 4A and 4B illustrate operation of the embodiment of the invention, wherein FIG. 4A shows an example of a long sampling period, and FIG. 4B shows an example of a short sampling period. Note that since the period for the sample and hold period is normally fixed, if the sampling pulse width is extended, the hold time will be reduced. On the contrary, if the sampling pulse width is reduced, the hold time will be extended.

Referring to FIG. 4A, the amount of generated charges increases when the sampling time is long, and the capacitor voltage V_{C} on the storage capacitor of the sustain device 115 also increases. The capacitor voltage V_{C} is compared with a predetermined threshold voltage by a comparator 122, and a level 1 is determined since the capacitor voltage V_{C} exceeds the threshold voltage (indicated as a dash line). On the other hand, referring to FIG. 4B, with the same incident light flux, the voltage does not rise due to a shorter sampling period, and a level 0 is determined since the voltage does not reach the threshold value.

Therefore, the most suitable sampling period under a certain light flux to determine whether a level 0 or 1 has been reached is obtained by adjusting the sampling period with repeated analysis.

In this embodiment, although the voltage exceeding the threshold voltage is determined as a level 1, it also can be determined as a level 0, dependent upon requirements,

In addition, by changing the sampling pulse width to at least four powers of two, preferably to at least sixteen powers of two, appropriate patterns can be determined.

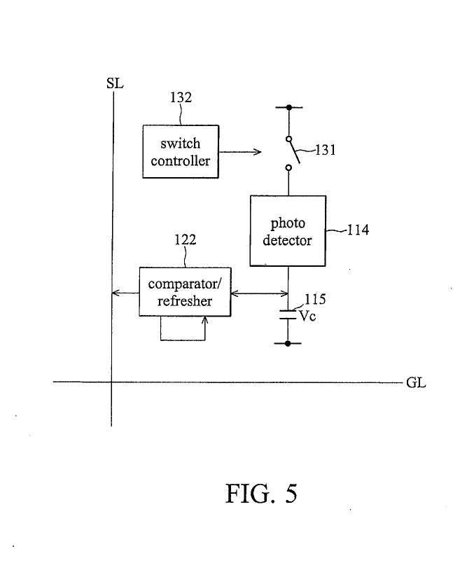

FIG. 5 shows a schematic diagram according to the second embodiment of the invention. Although the sampling period in this embodiment is also adjusted, the manner is different than that of the first embodiment. The power voltage for activating the photo detector 14 is kept constant, and the period for providing power can be adjusted by a sampling switch 131 and a switch controller 132 for controlling the sampling switch 131 in each pixel.

In this embodiment, since the simple circuit to control the power connection of the photo detector is used, it is advantageous in that area is reduced and aperture ratio is increased. Further, since the timing is accurately controlled, it is unnecessary to be concerned about the accuracy of the sampling period.

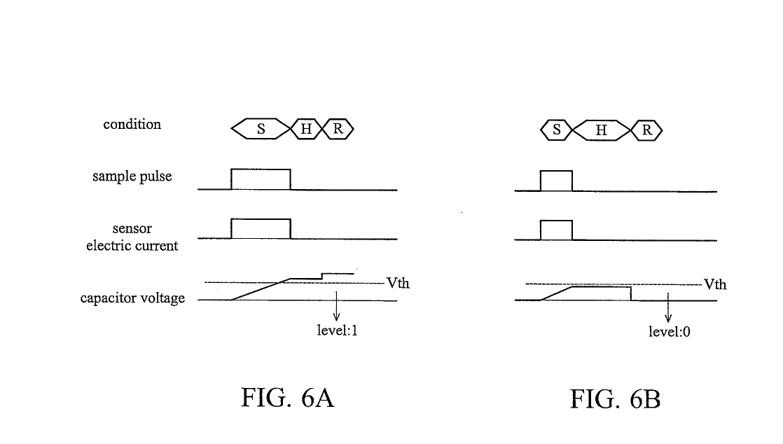

FIGS. 6A and 6B are timing diagrams of the circuit in FIG. 5. As shown, an adjustment of the sampling pulse width shown in FIGS. 4A and 4B is replaced by adjusting the turn-on period of the sampling switch.

By adjusting the turn-on period of the sampling switch, levels 1 and 0 can be obtained with identical light intensity, which is the same situation as in FIG. 4.

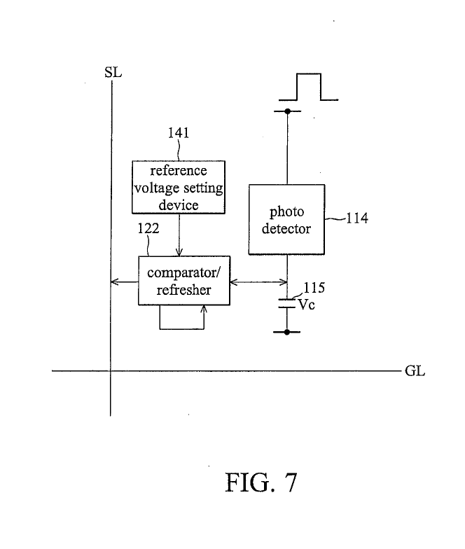

FIG. 7 shows a schematic diagram according to the third embodiment of the invention. In this embodiment, the sampling period is kept constant, but the threshold voltage for the determination digital level is changed. That is, a reference voltage setting device 141 sets a reference voltage as a determination base Vref for a comparator/refresher circuit 122 of an analog to digital converter. The reference voltage Vref can be adjusted to at least four powers of two or at least sixteen powers of two and be output. The reference voltage can be accurately obtained by known technology such as resistance division.

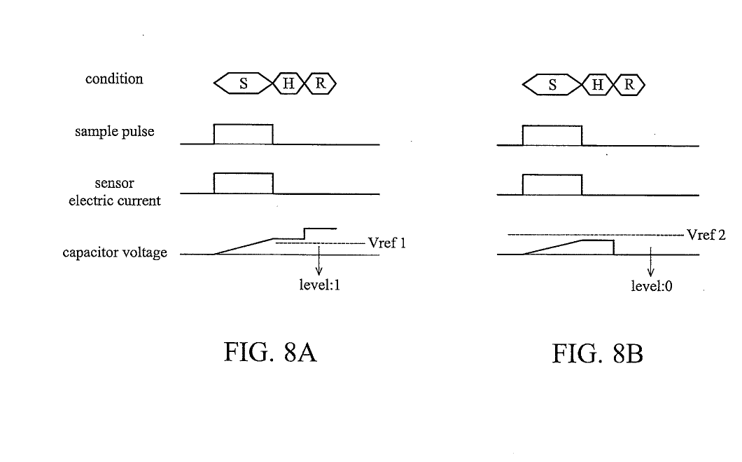

FIGS. 8A and 8B illustrate operation of the embodiment of the invention. Under the situation of the same sampling pulse and sample period, level 1 is determined once a lower reference level Vref1 is set (FIG. 8A), and level 0 is determined once a higher reference level Vref2 is set (FIG. 8B).

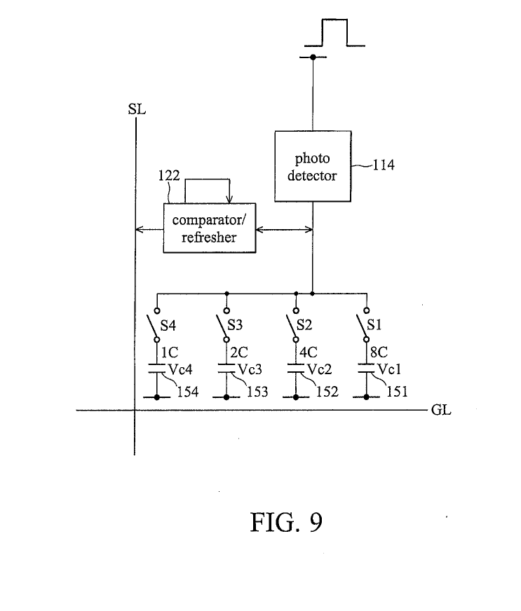

FIG. 9 shows a schematic diagram according to the fourth embodiment of the invention. In this embodiment, although the sampling pulse and the sampling period is kept constant, the capacitor acting as a sustain device can be changed. In FIG. 9, capacitances of the capacitors 151, 152 153, 154, respectively connected to switches S1, S2, S3, S4, are 8C, 4C, 2C, C, respectively. The voltages generated by each capacitor are Vc1, Vc2, Vc3, and Vc4, respectively.

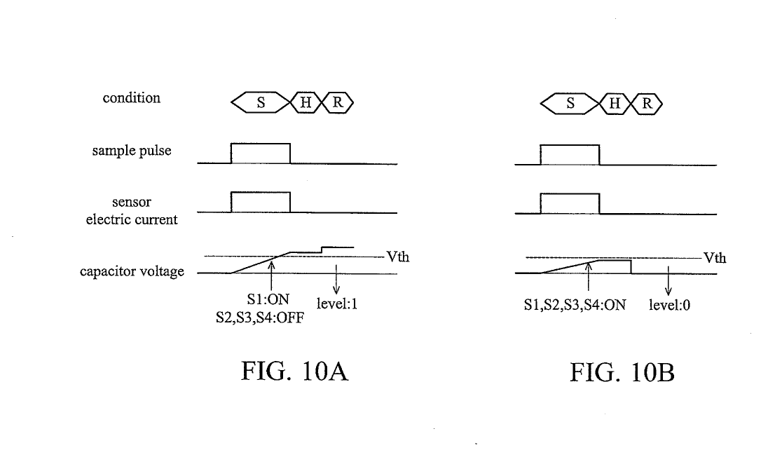

If the amount of the charges generated by the photo detector 114 is constant, lower voltage is generated by the capacitor with larger capacitance. FIGS. 10A and 10B show the above operation. Referring to FIG. 10A, only the capacitor 151 stores charges while only the switch S1 is turned on, and the voltage is dramatic raised and over the threshold Vth. Thus, level 1 is determined. On the contrary, referring to FIG. 10B, since all switches S1, S2, S3, and S4 are turned on, charges are separately stored in capacitors 151, 152 153, and 154, the speed of raising the voltage is decreased. Since the voltage does not surpass the threshold Vth even during the hold period, a level 0 is determined.

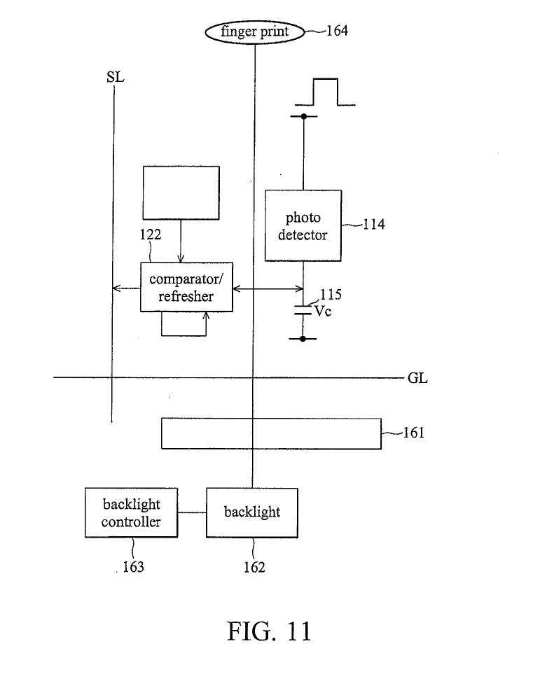

FIG. 11 shows a schematic diagram according to the fifth embodiment and the sixth embodiment of the invention. Here, the photo detector 114, the hold device 115, and the comparator/refresher circuit 122 are the same as the aforementioned described. Note that an analyzed light is focused.

In the fifth embodiment, a back light 162 is disposed under the liquid crystal layer 161, and the light flux of the back light 162 is changed by adjusting the output voltage of the back light controller 163.

Thus, if the light flux of the back light increases, the slope of the rising capacitor voltage is adjusted because the light flux reflected by the fingerprint 164 and emitted to the photo detector 114 increases.

In the sixth embodiment, light flux of the back light is kept constant, and transmittance of the liquid crystal layer 161 is adjusted during photo detection. The transmittance of the liquid crystal layer 161 is changed by adjusting the voltage provided by source lines SL and applied to the liquid crystal layer.

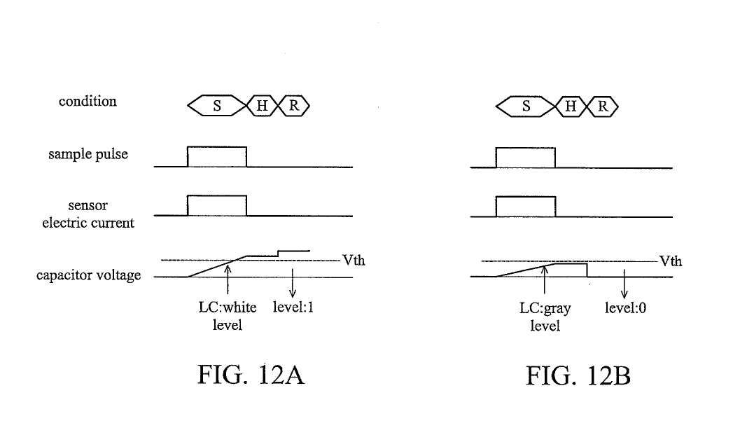

FIGS. 12A and 12B show operation of the sixth embodiment of the invention. In FIG. 12A, since the liquid crystal is under the greatest transmittance of white level, the reflection amount of the fingerprint 164 is higher and a rising rate of the capacitor voltage is also high, and a level 1 is thus determined when the capacitor voltage exceeds the threshold voltage Vth. Conversely, in FIG. 12B, since the liquid crystal is under the lower transmittance of gray level, the reflection amount of the fingerprint 164 is smaller and the rising rate of the capacitor voltage is relatively lower. Because the capacitor voltage cannot exceed the threshold voltage Vth in the sampling period, a level 0 is determined.

Meanwhile, the light flux of the back light and the transmittance of the liquid crystal layer can be changed.

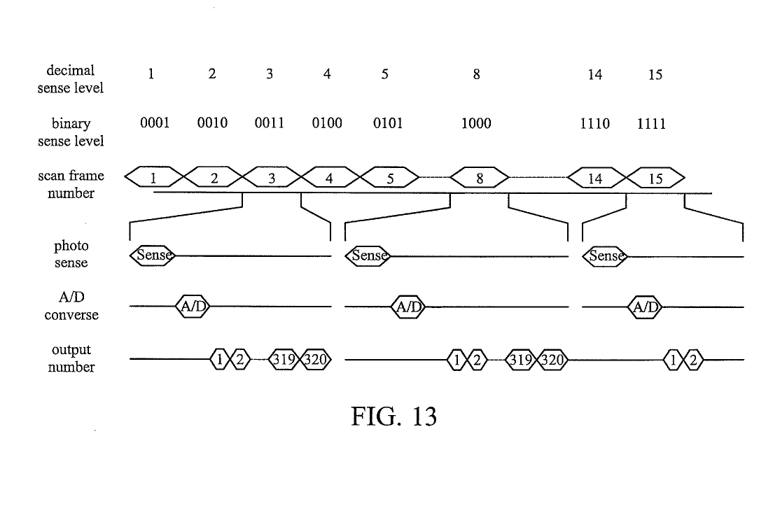

FIG. 13 is a timing diagram to control the sensitivity of a photo detector according to the embodiments of the invention. The timing diagram is expressed by fifteen powers of binary bits of sensitivity levels, the liquid crystal display elements can be formed with 320 lines.

Referring to FIG. 13, three sensitivity levels are detected which include sensitivity level 3 (binary numeral 0011), sensitivity level 8 (binary numeral 1000), and sensitivity level 15 (binary numeral 1111).

The analyzing sequences of each level are the same. First, incident light is detected, analog to digital conversion is then performed and a threshold voltage is set. Subsequently, analyzed data of each line is sequentially readout according to the threshold voltage.

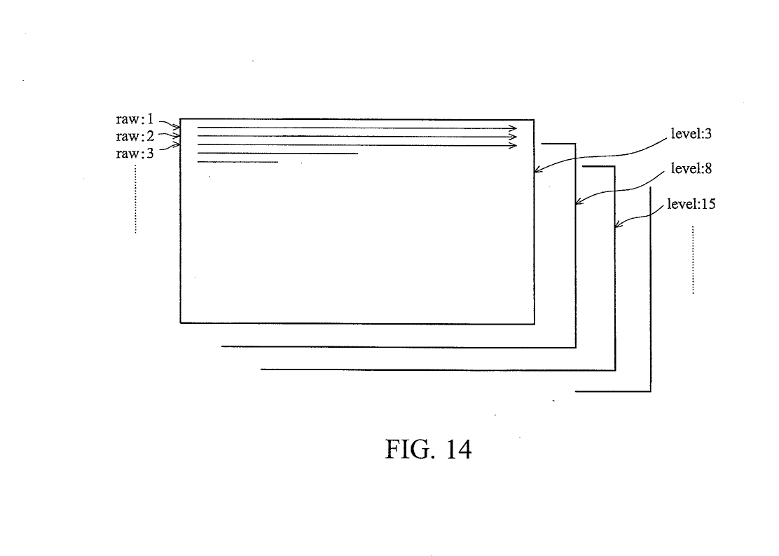

FIG. 14 shows statuses of analyzed data corresponding to levels 3, 8, and 15 in FIG. 13. By observing the analyzed data, any level without the so-called “white smash” or “black smash” is determined according to the aforementioned three levels and thus, the fingerprint level can clearly be observed. For example, if the level 8 is in a good condition, regarding the upper and lower levels, the best level can be decided by performing the same analyzing procedures.

Additionally, the best level can also be decided by sequentially retrieving all data from a level 1.

In the aforementioned embodiments, although sensitivity levels can be adjusted and expressed by binary orders, an additional amount of circuit arrangement corresponding to the display device can also be freely set.

As mentioned, the display devices according to the embodiments of the invention use one bit structure but process the data with a mean value so that comparative identification accuracy can be increased.

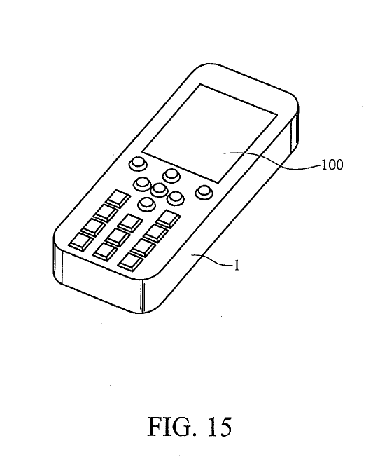

In addition, the aforementioned liquid crystal display is applicable to the display device 100 of the mobile phone sets 1 as shown in FIG. 15, but is not limited thereto. Other electronic devices, such as digital cameras, personal digital assistances (PDAs), notebook computers, desktop computers, televisions, car displays, global positioning systems (GPS), avionic displays or portable DVD players are also applicable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a plurality of display pixel portions disposed at intersections by columns of gate lines and rows of source lines and arranged as a matrix, wherein each display pixel portion comprises:
a liquid crystal element;
a photo detector detecting an incident light;
a hold device sustaining an analog first data corresponding to a light flux of an incident light detected by the photo detector; and
a data determination device generating a second data according to the first data sustained by the hold device;
a gate driver selectively activating the gate lines;
a source driver providing display data to the source lines;
an output device retrieving an analyzed output data, wherein the analyzed output data is the second data output by the data determination device through the source lines; and
a sensitivity control device changing a determination base of the analyzed output data corresponding to intensity of the incident light.

2. The display device as claimed in claim 1, wherein the photo detector is a photodiode.

3. The display device as claimed in claim 2, wherein the hold device is a capacitive element connected to the photo detector via a switch.

4. The display device as claimed in claim 3, wherein the data determination device comprises a voltage comparator varying status according to a voltage generated by charges stored in the capacitive element.

5. The display device as claimed in claim 1, wherein the sensitivity control device controls functions of the photo detector by time division to control the first data.

6. The display device as claimed in claim 1, wherein the first data output by the photo detector is an electric current, and the photo detector controls the first data by controlling the magnitude of the electric current.

7. The display device as claimed in claim 1, wherein the hold device comprises a capacitor portion with a plurality of capacitors connected in parallel, and the sensitivity control device controls the first data by controlling the capacitance of the capacitor portion.

8. The display device as claimed in claim 7, wherein the capacitance of the plurality of capacitors is a value of the power of two.

9. The display device as claimed in claim 4, wherein the sensitivity control device controls a determination of the voltage comparator for the first data by varying a reference voltage provided to the voltage comparator.

10. The display device as claimed in claim 1, wherein the sensitivity control device is a light flux controller to change the flux of a back light unit.

11. The display device as claimed in claim 1, wherein the sensitivity control device is a voltage controller changing voltage applied to the liquid crystal element to change transmission thereof.

12. The display device as claimed in claim 11, wherein the sensitivity control device changes a determination base of the analyzed output data to a value of the power of two.

13. An electronic device comprising the display device as claimed in claim 12, wherein the electronic device comprises mobile phones, digital cameras, personal digital assistances (PDAs), notebook computers, desktop computers, televisions, car displays, global positioning systems (GPS), avionic displays, or portable DVD players.
